(19) United States
(12) Patent Application Publication
(10) Pub. No.: US 2015/0007246 A1
(43) Pub. Date: Jan. 1, 2015

(54) INTERFACE APPARATUS

(71) Applicant: Technetix B.V., Veenendaal (NL)

(72) Inventor: Jan Ariesen, Veenendaal (NL)

(21) Appl. No.: 14/371,847

(22) PCT Filed: Feb. 7, 2013
(86) PCT No.: PCT/EP2013/052394

§ 371 Date: Jul. 11, 2014

(30) Foreign Application Priority Data
Feb. 8, 2012 (GB) 1202147.3

(51) Int. Cl. H04N 21/422; H04N 21/238; H04N 21/239

(52) U.S. Cl. CPC H04N 21/42207; H04N 21/239; H04N 21/238
USPC 725/127

(57) ABSTRACT

There is provided interface apparatus (40) for use in a broadband and/or CATV network (10), the apparatus (40) comprising signal separation means (50, 50′) to create separate downstream and upstream signal paths (46, 48′) and an amplifier means (54) for amplifying upstream signals, wherein the amplifier means (54) is positioned in the upstream signal path and is in communication with a signal detection means (56) operable to power the amplifier means (54) dependent on a signal level of the upstream signal. The signal detection means (56) is positioned downstream of the amplifier means in the upstream path. The signal detection means (56) incorporates a switching element (58) responsive to a detected signal level to interrupt power (60) to the amplifier means (54) and so prevent passing along the upstream path.

### FIELD OF THE INVENTION

This invention relates to interface apparatus for use in a distribution network, such as a cable television network and/or broadband network.

### BACKGROUND TO THE INVENTION

Distribution networks such as cable television (CATV) networks and/or broadband networks are susceptible to noise ingress in the upstream path from cable subscriber to cable provider. The ingress affects signal quality and signal transmission capability. If the ingress is sufficiently large, it will destroy the data link between the subscriber and the provider.

80-90% of the ingress comes from individual subscribers and if a network has 1000 subscriber connections, the ingress of all these connections add together in the upstream signal received at the head end of the network. This creates a large amount of noise in the signal returned to the cable provider.

It is known to use interface apparatus to disconnect a subscriber's upstream path when the subscriber is not transmitting any data. That particular subscriber then does not feed any ingress into the network. As soon as the subscriber wishes to send data, the upstream path is reconnected to allow the subscriber to transmit data upstream to the head end.

It is an aim of the present invention to further improve on selective upstream transmission.

### SUMMARY OF THE INVENTION

In accordance with one aspect of the present invention, there is provided interface apparatus for use in a broadband and/or CATV network, the apparatus comprising signal separation means to create separate downstream and upstream signal paths and an amplifier means or amplifier device for amplifying upstream signals, wherein the amplifier means is positioned in the upstream signal path and is in communication with a signal detection means operable to power the amplifier means dependent on a signal level of the upstream signal. When there is no upstream signal or very low levels of upstream signal such that there is no subscriber initiated signal passing upstream, the signal detection means detects this and stops power to the amplifier. The unpowered inactive amplifier breaks the upstream path which prevents signal noise or ingress travelling upstream. Where the signal detection means detects a significant signal level indicating upstream communication between the subscriber and the provider, the signal detection means maintains the power to connection to the amplifier. By selectively powering the amplifier means in this way, and routing the upstream signal path through the amplifier means such that all the upstream signal path passes through the amplifier means, the amplifier means acts as a break point in the upstream path. Overall power consumption is reduced as the amplifier will only be powered when the upstream signal path is active.

The signal separation means or signal separation apparatus preferably comprises filter means or filter, such as a high pass filter combined with a low pass filter, or a diplex filter.

Preferably the signal detection means is positioned downstream of the amplifier means. As will be appreciated, the signal detection means must necessarily be positioned in the upstream path and typically will be positioned between a low pass filter and the amplifier.

The signal detection means preferably incorporates a switching element. When the upstream signal level is very low or zero, the signal detection means operates the switch to break the connection between the power supply and the amplifier, ensuring that the amplifier is no longer operative and does not consume power and does not allow upstream signals in the form of ingress to pass through it.

Preferably the signal detection means is a log amplifier with level detector.

Preferably the amplifier means is responsive to power to restore the upstream path in less than 160 ns once an upstream signal is detected. Thus typically the amplifier will be responsive within a range of 160 ns to 10 ns.

Preferably the signal detection means is operable within a time of 4 to 1 μs.

In accordance with another aspect of the present invention, there is also provided a distribution network having at least one interface apparatus as aforesaid. Preferably the distribution network has a plurality of such interface apparatus.

The invention will now be described, by way of example, with reference to the accompanying drawings in which:

FIG. 1 is a schematic view of a distribution network; and

FIG. 2 is a schematic circuit diagram of a network interface unit embodying the is present invention.

### DESCRIPTION OF THE DRAWINGS

FIG. 1 shows a diagrammatic view of a distribution network 10 such as used in CATV and/or broadband networks. Signals are transmitted to and received from a cable provider at antenna 12 and passed to a head end 14 which is in two-way communication with one or more hubs 16, only one of which is shown. Each hub 16 has a number of paths 22 to separate nodes 24 which are in turn connected to respective distribution points 26 or cabinets from which run a large number of signal paths or drops 30, each drop communicating with a set-top box 32 associated with a cable subscriber. Typically each distribution point 26 will serve 100 houses with each hub 16 serving 5-40 nodes. Thus typically each hub 16 serves around 4000 houses.

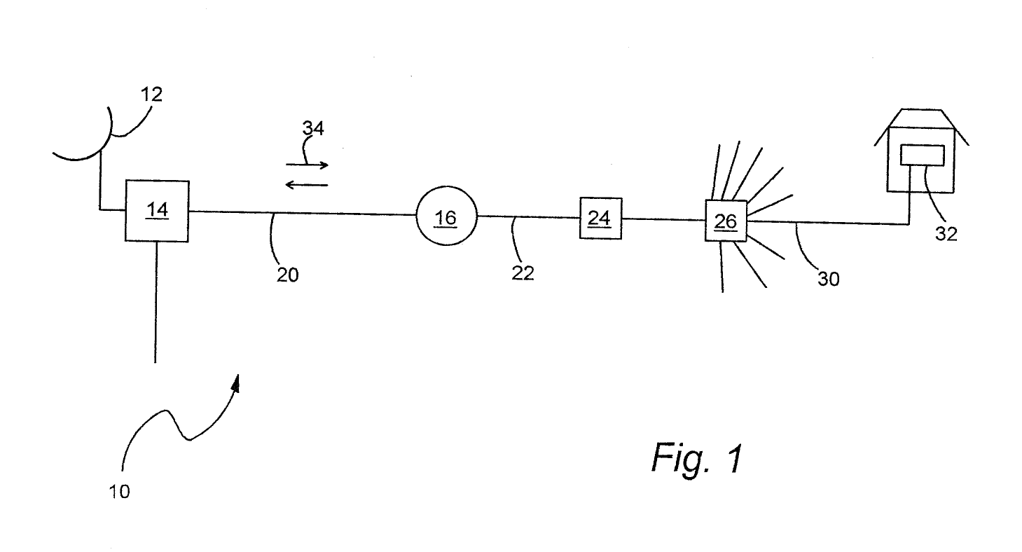

The two-way signal path is provided between subscriber and network provider by way of the cabling and antenna link. Signal transmission from hub to subscriber is achieved using a series of amplifiers and splitters. Each subscriber contributes to noise ingress in the upstream return path from the subscriber to the cable provider and thus the noise contribution from, for example, 4000 homes is summed and added to the upstream path. This noise ingress degrades the signal quality of the entire network 10.

FIG. 2 illustrates a bidirectional network interface unit 40 suitable for use in such a network positioned between drop 30 and set-top box 32 of the subscriber, typically directly after the isolator or in-home starting point. Network interface unit 40 comprises an input 42 connected to drop 30 and which allows two-way communication with the network provider and output 44 connectable to the subscriber's equipment, for example a set-top box. Within the interface unit 40, upstream and downstream signals are split into two separate paths 46, 48 using diplex filters 50, 50′, with the downstream high-frequency signal passing between the high pass side of filters 50, 50′ and the upstream low frequency signal passing between the low pass portion of filters 50, 50′.

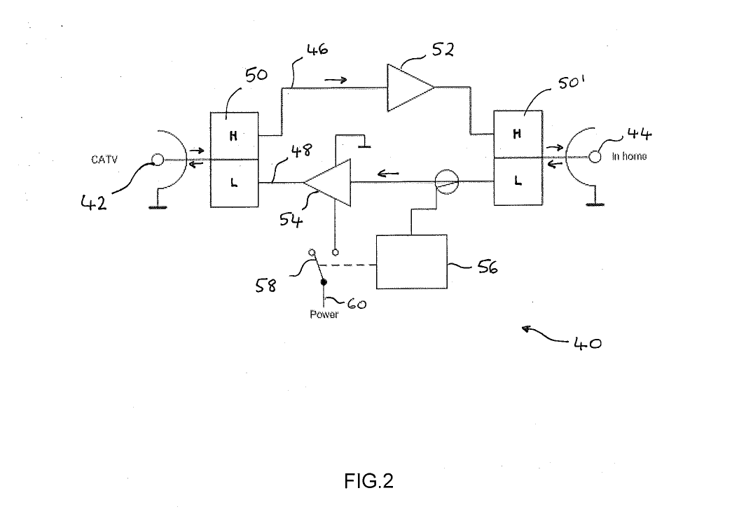

Amplifier 52 is provided in the downstream path for amplifying signals as they pass between filters 50, 50′. Amplifier 54 is positioned in the upstream path between the low pass portion of filters 50, 50′ such that for signals to pass upstream they must pass through amplifier 54, with the entire upstream signal routed through amplifier 54. Level detector 56 is also positioned in the upstream path, downstream of amplifier 54 between amplifier 54 and filter 50′. All upstream signals passing from filter 50′ to filter 50 are detected by detector 56 before they reach upstream amplifier 54. Level detector 56 and associated switch 58 are connected between the upstream path 48 and power transmission path 60 to amplifier 54. Level detector 56 is configured to open and close switch 58 dependent on the detected upstream signal level, opening switch 58 to interrupt the power supply to amplifier 54 in response to upstream signals below a predetermined power level, for example 30 dBmV.

When there is no subscriber initiated upstream signal from in-home to the CATV network level, detector 56 sees no, or minimal, upstream signal and operates switch 58 to break the power supply 60 to upstream amplifier 54. The amplifier can no longer function without power and creates a break in the upstream path, interrupting the connection between the in-home and CATV network. Signals, and in particular ingress or noise signals, can no longer pass upstream.

If the in-home network sends data upstream, the frequency of the signal generated by the subscriber is above the level associated with any noise signal and level detector 56 detects the signal and closes switch 58 to restore power to upstream amplifier 54. Amplifier 54 is now operational and amplifies the upstream signal and transmits it onwards to the CATV network.

It is important that the switching is done quickly during the run-in time of the data transmission from the subscriber to ensure that data does not get lost. Typically level detector 56 will be capable of restoring power within 5 μs, and more preferably 3 μs with the amplifier restarting within less than 160 ns when power is restored.

Even with such short times for restoring power, the first data sent can be affected and may need to be re-sent. The IP (internet Protocol)/Docsis (Data over cable Service Interface Specification) protocol is designed to take this into account and the protocol is developed to resend the first data without impact on the communication itself. Once a connection is made, the data will be transmitted in the timeslots available. To prevent switch 58 opening or closing after each transmission, the connection remains in place for ten minutes after the last data is sent. After this ten minute period, switch 58 opens again and the amplifier upstream module 54 goes to sleep and does not consume power. When a new data package is sent from the interactive device, the process recommences, closing switch 58.

During periods of time when there are no subscriber initiated upstream signals, level detector 56 ensures the amplifier 54 is switched off and not consuming power. By placing the amplifier 54 in the upstream path, switching off the power has the added benefit of also breaking the upstream connection and preventing noise ingress from passing from the subscriber to the rest of the network when the subscriber upstream connection is inactive. There are significant reductions in the overall power usage of the amplifier 54 as it is only intermittently switched on.

1. Interface apparatus for use in a broadband and/or CATV network, the apparatus comprising a signal separation apparatus to create separate downstream and upstream signal paths and an amplifier device for amplifying upstream signals, wherein the amplifier device is positioned in the upstream signal path and is in communication with a signal detector operable to power the amplifier device dependent on a signal level of the upstream signal.

2. Interface apparatus according to claim 1, wherein the entire upstream signal path is routed through the amplifier means.

3. Interface apparatus according to claim 1, wherein the signal separation apparatus comprises a filter.

4. Interface apparatus according to claim 1, wherein the signal detector is positioned downstream of the amplifier device in the upstream path.

5. Interface apparatus according to claim 1, wherein the signal detection apparatus incorporates a switching element responsive to a detected signal level.

6. Interface apparatus according to claim 1, wherein the signal detector is a log amplifier with level detector.

7. Interface apparatus according to claim 1, wherein the amplifier device is responsive to become operative in less than 160 ns.

8. Interface apparatus according to claim 1, wherein the signal detection apparatus is operative within a time of 4 to 1 μs.

9. A distribution network having at least one interface apparatus according to claim 1.

10. A distribution network having a plurality of interface apparatus according to claim 1.
